(19) United States
(12) Patent Application Publication
(10) Pub. No.: US 2026/0001967 A1
(43) Pub. Date: Jan. 1, 2026

(54) SYNTHETIC HEXASACCHARIDES MIMICS OF HEPARIN SHOWING HEPARANASE INHIBITION ACTIVITY

(71) Applicant: CENTRO ALTA TECNOLOGIA ISTITUTO DI RICERCHE CHIMICHE E BIOCHIMICHE G. RONZONI S.R.L., Milan (IT)

(72) Inventors: Annamaria NAGGI, Milan (IT); Maurice PETITOU, Milan (IT); Ming Hong NI, Milan (IT)

(21) Appl. No.: 18/992,639

(22) PCT Filed: Jul. 6, 2023
(86) PCT No.: PCT/EP2023/068684

§ 371 Date: Jan. 9, 2025

(30) Foreign Application Priority Data
Jul. 14, 2022 (IT) 102022000014806

(51) Int. Cl. C08B 37/00

(52) U.S. Cl. CPC C08B 37/0078

(57) ABSTRACT

The present invention is directed to hexasaccharides mimetics of heparins presenting remarkable heparanase inhibition activity. The compounds have formula (I), wherein R¹ is selected from the group consisting of NH₂, NHSO₃Na, NHAc; R² is selected from the group consisting of NH₂, NHSO₃Na, NHAc; R³ is selected from the group consisting of Bn, H; R⁴ is selected from the group consisting of Ac, H, SO₃Na; R⁵ is CO₂Na; R⁶ is selected from the group consisting of Me, Ethyl, Alkyl, alkyl azide, alkynyl, cholestanol aglycon; R⁷ is selected from the group consisting of CH₂OH, COOH.

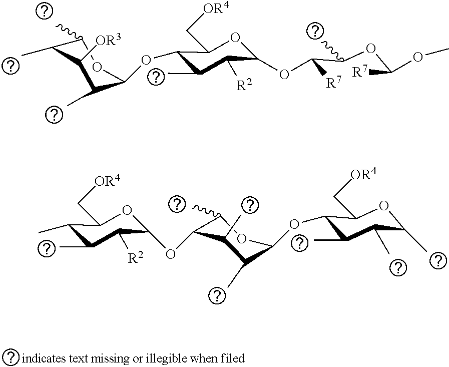

### FIELD OF THE INVENTION

The present invention is directed to synthetic hexasaccharides showing remarkable heparanase inhibition activity.

### BACKGROUND OF THE INVENTION

Heparan sulfate (HS) refers to a family of glycosaminoglycan chains present in about 20 glycoproteins, the proteoglycans (PG), distributed mainly in the extracellular matrix and at the cell surface, but also inside the cell (Thibault Annaval et al., Heparan Sulfate Proteoglycans Biosynthesis and Post Synthesis Mechanisms Combine Few Enzymes and Few Core Proteins to Generate Extensive Structural and Functional Diversity, Molecules, 2020, 25, 4215; doi:10.3390/molecules25184215). PGs exert their biological functions by interacting with a vast array of protein ligands including the most recently discovered SARS-COV-2 (Thomas Mandel Clausen et al, SARS-COV-2 Infection Depends on Cellular Heparan Sulfate and ACE2. Cell 183, 1-15, Nov. 12, 2020).

Heparanase (HPSE) is a β-D-endoglycosidase capable of cleaving the HS chains of proteoglycans and thus to regulate the function of many proteins interacting with HS. HS cleavage by heparanase may affect diverse biological processes like, for instance, inflammation, angiogenesis and cell migration (R. Goldberg et al., Versatile role of heparanase inflammation, Matrix. Biology, 2013, 32(5), 234-240) through release and activation of growth factors, cytokines and other bioactive molecules, the end result being tumor growth and metastasis (I. Vlodavsky et al., Heparanase: Structure, Biological Function, and Inhibition by Heparin-Derived Mimetics of Heparan Sulfate, Current Pharmaceutical Design, 13(2007), 2057-2073). HPSE is also involved in diabetes and arteriosclerosis diseases. Increased levels of HPSE have recently been found in Covid-19 patients (B. Buijsers et al., C, Front. Immunol. 11:545047. doi: 10.3389/fimmu.2020.545047). HPSE is the only enzyme in mammals capable of this activity. A second heparanase has been discovered, heparanase-2, but it is devoid of enzymatic activity.

WO 2015/062951 discloses a process for the preparation of a glucosaminoglycan derivative inhibiting heparanase, comprising: N-desulfation of from 25% to 100% of the N-sulfated residues of a glucosaminoglycan; oxidation, preferably by periodate at a pH of from 5.5 to 10.0, of from 25% to 100% of the 2-N—, 3-O-non-sulfated glucosamine residues and of the 2-O-non-sulfated uronic acid residues of said glucosaminoglycan, under conditions effective to convert adjacent diols and adjacent OH/NH₂ to aldehydes; reduction, preferably by sodium borohydride, of said oxidized glucosaminoglycan, under conditions effective to convert said aldehydes to alcohols. The document discloses that, by reducing Mw, IC₅₀ increases up to 750 ng/ml for a Mw of about 5 kDa.

Minghong Ni et al., (Investigating Glycol-Split-Heparin-Derived Inhibitors of Heparanase: A Study of Synthetic Trisaccharides Molecules 2016, 21, 1602; doi:10.3390/molecules21111602) disclose trisaccharides with heparanase inhibition property; however, the compound GlcN(Ns,6s)-GlcA(gs)-GlcN(Ns,1,6anh) shows an IC₅₀ of 2000 ng/ml.

It would be therefore important to develop synthetic compounds which show a good activity as HPSE inhibitors.

### SUMMARY OF THE INVENTION

The present invention is directed to a new class of hexasaccharides mimetics of heparin presenting a significant heparanase inhibition activity. The compounds have structure:

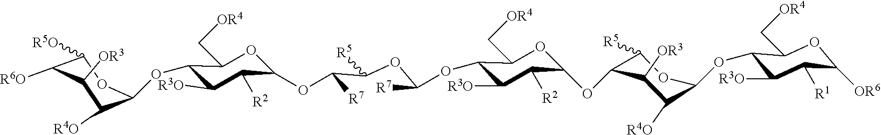

Wherein R¹ is selected from the group consisting of NH₂, NHSO₃Na, NHAc; R² is selected from the group consisting of NH₂, NHSO₃Na, NHAc; R³ is selected from the group consisting of Bn, H; R⁴ is selected from the group consisting of Ac, H, SO₃Na; R⁵ is CO₂Na; R⁶ is selected from the group consisting of Me, Ethyl, Alkyl, alkyl azide, alkynyl, cholestanol aglycon; R⁷ is selected from the group consisting of CH₂OH, COOH.

### DETAILED DESCRIPTION OF THE INVENTION

The hexasaccharides according to the present invention are obtainable by glycosplit reaction of a uronic acid ring of the following hexasaccharide:

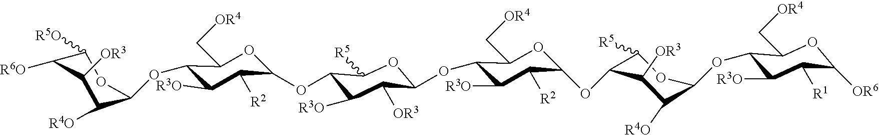

Wherein R¹, R², R³, R⁴, R⁵, R⁶ and R⁷ have the above defined meanings. The hexasaccharide is composed of alternating rings of glucosamine sulfate and uronic acid. The term uronic acid comprises both iduronic acid and glucuronic acid.

In a preferred embodiment, the hexasaccharides have formula:

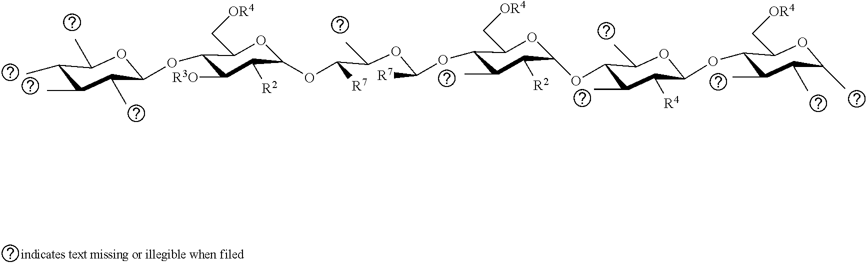

In another preferred embodiment, the hexasaccharides have formula:

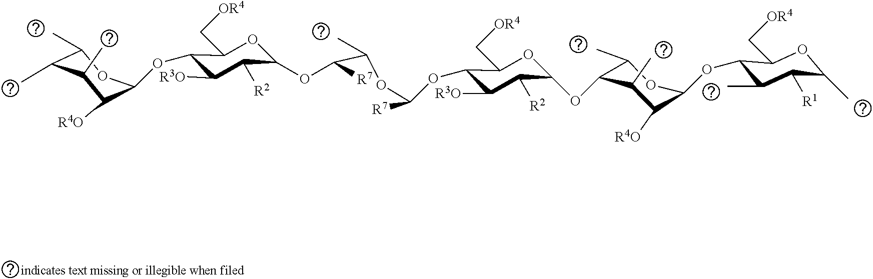

In another preferred embodiment, the hexasaccharides have formula:

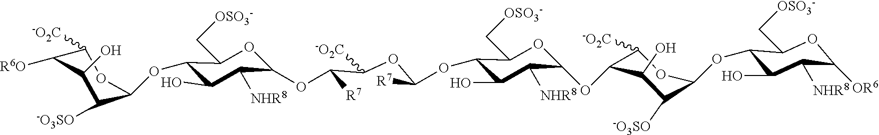

Wherein R⁶ and R⁷ have the above defined meanings, R⁸ is selected from the group consisting of SO₃Na, Ac.

When the gs ring is a glucuronic acid ring, the hexasaccharides have formula:

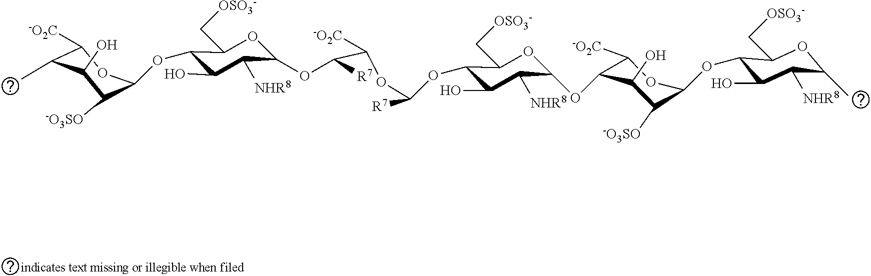

When the gs ring is an iduronic acid ring, the hexasaccharides have formula:

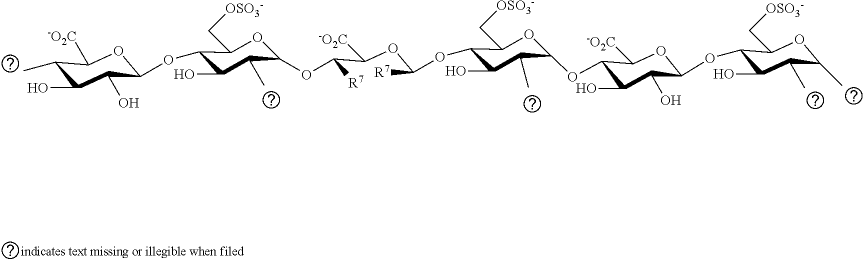

The compounds according to the invention can be prepared starting from the pivotal hexasaccharide 12,13 and 16 (Scheme 1) that after functionalization presents a single residue (glucuronic acid) susceptible to periodate oxidation, and from which different target structures (13-18) can be derived.

To prepare 12 we adopted (Scheme 1) a classical disaccharide building-block approach (C. Tabeur et al., Oligosaccharides corresponding to the regular sequence of heparin: chemical synthesis and interaction with FGF-2. Bioorg. Med. Chem. 1999, 7, 2003-2012) based on the trichloroacetimidate glycosylation method (R. R. Schmidt, W. Kinzy, Adv. Carbohydr. Chem. Biochem. 1992, 50, 21-123). The fully orthogonally protected hexasaccharide 9 was thus obtained from the known (M. Petitou et al., Synthesis of Heparin Fragments: A α-methyl Pentaoside with High Affinity for Antithrombin II, Carbohy. Res. 1987, 167, 67-75) 3 that was first coupled with the known 2 (C. A. A. van Boeckel et al., Synthesis of a Pentasaccharide Corresponding to the Antithrombin III Binding Fragment of Heparin, Journal of Carbohydrate Chemistry, 1985, 4 (3), 293-321, https://doi.org/10.1080/07328308508070182), in the presence of tert-butyldimethylsilyl triflate, in dichloromethane at −30° C. to give the tetrasaccharide 4 in 65% yield. The hexasaccharide sequence was completed by reaction under similar conditions with the trichloroacetimidate disaccharide 8 itself classically obtained from 6. A mixture of the two anomers was formed (56%, α/β=4/1). After saponification to remove the acetyl groups and cleave the methyl esters, preparative HPLC allowed to separate 10 from its β-anomer. Following O-sulfation (11) and hydrogenolysis, 12 was in part N-sulfated by sulfur trioxide pyridine complex in aqueous sodium hydrogen carbonate to obtain 13 (78%), it was also in part N-acetylated by acetic anhydride in aqueous sodium hydrogen carbonate to give 16 (75%). The glycol-split derivatives were then obtained (Scheme 2). After periodate oxidative cleavage of 13 the resulting dialdehyde, that was not isolated, was reduced into 14 using sodium borohydride, or further oxidized by NaClO₂ in the presence of NaH₂PO₄ buffer at pH 5 (Pinnick oxidation) to give 15 (yield: 39%, 2 steps) after purification by an anionic exchanging column Mono Q, desalting and lyophilization. The same oxidation method yielded 17 and 18 from 16. All the structures of final products were confirmed by 1H- and 13C-NMR analysis (HSQC-dept, COSY, TOCSY, HMBC) and LC-MS. The inhibition of heparanase was evaluated using an assay based on the cleavage of the synthetic heparin pentasaccharide fondaparinux (Arixtra®; Aspen). Cleavage of fondaparinux by heparanase, yields a disaccharide that is assayed by colorimetry. The assay was essentially performed as described by Hammond (E. Hammond, C. P. Li, V. Ferro, Development of a colorimetric assay for heparanase activity suitable for kinetic analysis and inhibitor screening, Anal. Biochem. 396 (2010), 112-116, http://doi.10.1016/j.ab.2009.09.007.

Scheme 1

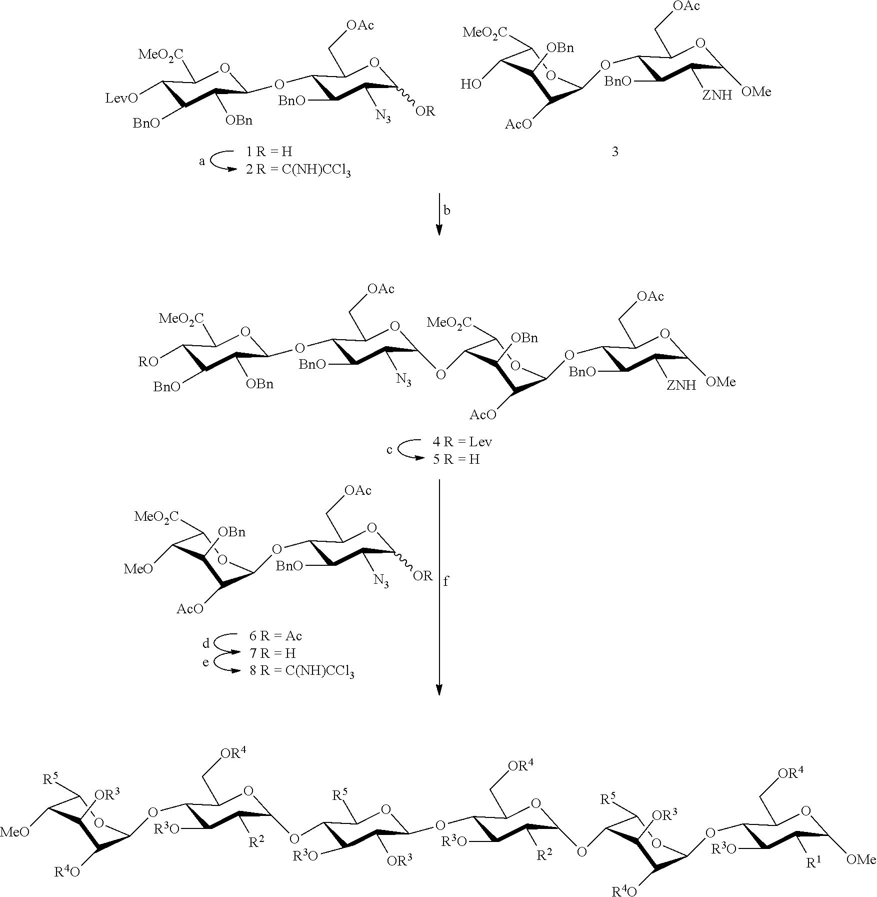

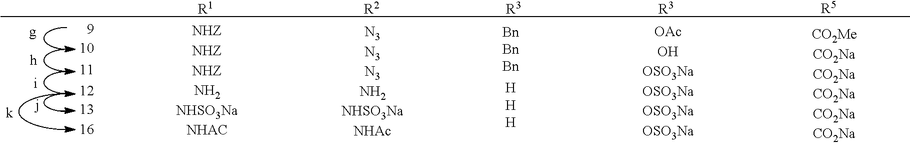

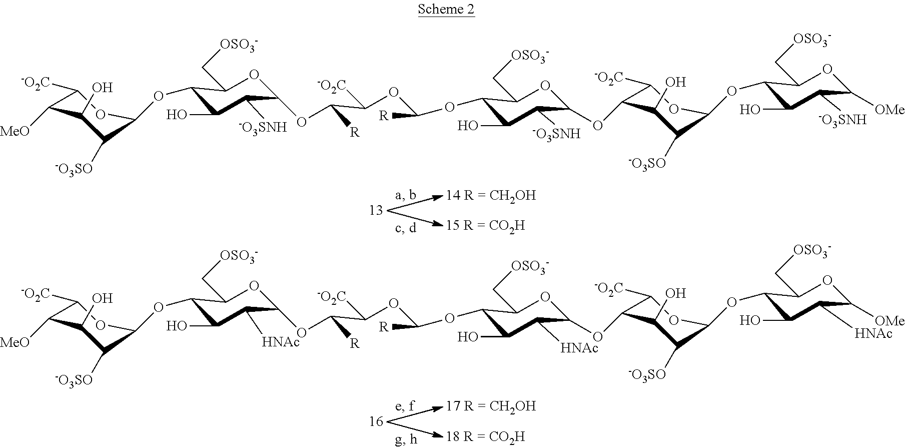

Serial dilutions of the compounds and of the reference roneparstat were tested. IC₅₀ values were ultimately determined using GraphPad software. The results are reported Table 1. Inhibition by hexasaccharides 12, 13 and 16 (Scheme 1), comprising an intact glucuronic acid unit was hardly detectable over the concentration range tested, with a tendency however for a better inhibition when the glucosamine units are N-sulfated rather than N-acetylated. This tendency was again observed after periodate cleavage (14 vs. 17) and particularly after introduction of the two carboxylic acid functions (15 and 18). Thus, the N-sulfated hexasaccharide 15 displayed an IC₅₀ of 70 nM (Scheme 2). Comparing the activity of 12 and 16 with other derivatives, our results clearly demonstrate the critical role played by gs and gs-ox uronic acid units. Comparison of the activities of 15 and 18, it appears that N-sulfated glucosamine are preferred over N-acetylated ones, despite the fact that in roneparstat N-acetyl groups only are present.

TABLE 1

| | |
|---|---|
| Compound | IC₅₀ |

| No. | μg/ml | μM |
|---|---|---|
| Roneparstat | 0.006 | |
| 12 | 50 | 30 |
| 13 | >50 | >26 |
| 14 | 10 | 5 |
| 15 | 0.15 | 0.07 |
| 16 | inactive | |
| 17 | inactive | |
| 18 | 38 | 21 |

In order to estimate the inhibition properties of a iduronic gs ring when compared to a glucuronic gs ring, trisaccharides corresponding to the three central rings of the structure (gs ring plus one ring on each side) have been prepared both with an iduronic ring and a glucuronic ring. The synthetic route is shown in Scheme 3.

Scheme 3

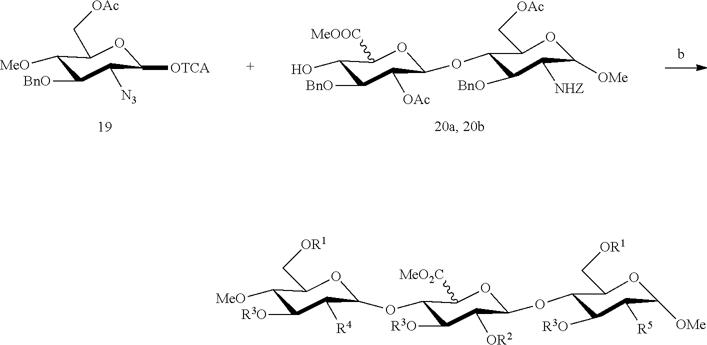

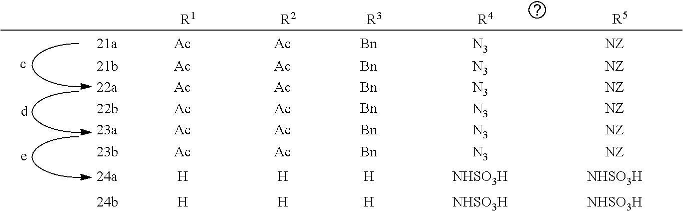

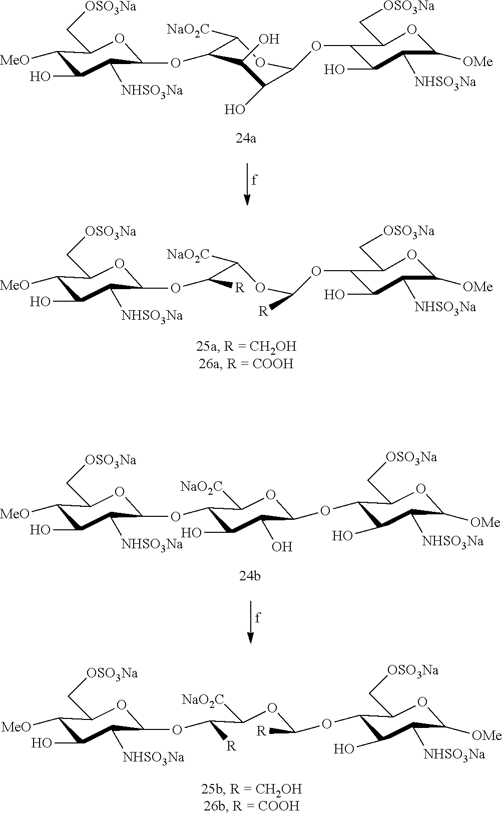

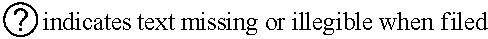

Trisaccharide 21a and 21b were obtained by coupling monosaccharide 19 (Minghong Ni et al., Investigating Glycol-Split-Heparin-Derived Inhibitors of Heparanase: A Study of Synthetic Trisaccharides, Molecules 2016, 21, 1602;) to 20a (M. Petitou et al., Synthesis of heparin fragments: A methyl α-pentaoside with high affinity for antithrombin III, Carbohydr. Res. 167 (1987), 67-75,) or 20b which was epimerized by DBU in DMF from 20a. The activator used in glycosylation reaction was TMSOTf/CH2Cl2/−20° C. Given the oligosaccharide's structure, it is needed to protect and deprotect orthogonally the hydroxyl group from time to time (V. Dimakos, et al, Site-Selective Functionalization of Hydroxyl Groups in Carbohydrate Derivatives, Chem. Rev. 118 (2018) 11457-11517). This may result in cumbersome multi-steps preparation. Among selective methods allowing to protect or deprotect one position among several bearing the same function, Magnesium methoxide in methanol (G. Tiruchinapally et al., Divergent Heparin Oligosaccharide Synthesis with Preinstalled Sulfate Esters, Chemistry, 17 (2011), 10106-10112) was chosen and optimized (4 equiv. Mg(OH)2 at −10° C. for 3-4 h) to selective deacetylate 21a and 21b in a satisfied yield 45-55%. After O-sulfation, saponification, hydrogenolysis and N-sulfation, 24a and 24b were obtained. 24a and 24b were subsequently oxidized by sodium periodate, reduced by sodium borohydride (called gs) to give 25a and 25b. 24a and 24b were oxidized by sodium periodate and further oxidized by NaClO2 (Pinnick oxidation) (called gs,ox) to give 26a and 26b.

The activity of the different compounds is shown in Table 2. It is possible to note that the compounds containing a glucuronic ring are in general more active than compounds comprising a iduronic ring. It is expected that this trend is also valid for hexasaccharide structures according to the invention.

TABLE 2

| | |
|---|---|
| Trisaccharide | IC₅₀ |

| Compound | (μg/ml) | μM (nmol/ml) |
|---|---|---|
| Roneparstat | 0.006 | |
| 24a (gluco) | 39 | 40.0 |
| 25a (gluco gs) | 37 | 37.9 |
| 26a (gluco di-carbossi) | Inactive | — |
| 24b (ido) | Inactive | — |
| 25b (ido gs) | 75 | 76.8 |
| 26b (ido di-carbossi) | 75 | 71.6 |

1. An hexasaccharide having formula 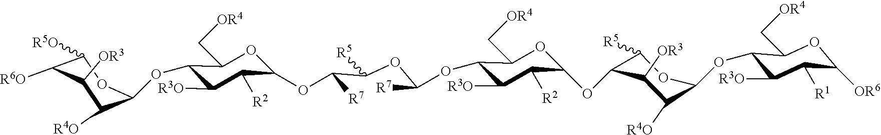
wherein R¹ is selected from the group consisting of NH₂, NHSO₃Na, NHAc;
R² is selected from the group consisting of NH₂, NHSO₃Na, NHAc;
R³ is selected from the group consisting of Bn, H;
R⁴ is selected from the group consisting of Ac, H, SO₃Na;
R⁵ is CO₂Na;
R⁶ is selected from the group consisting of Me, Ethyl, Alkyl, alkyl azide, alkynyl, cholestanol aglycon;
R⁷ is selected from the group consisting of CH₂OH, COOH.

2. The hexasaccharide according to claim 1 wherein the hexasaccharide has formula:

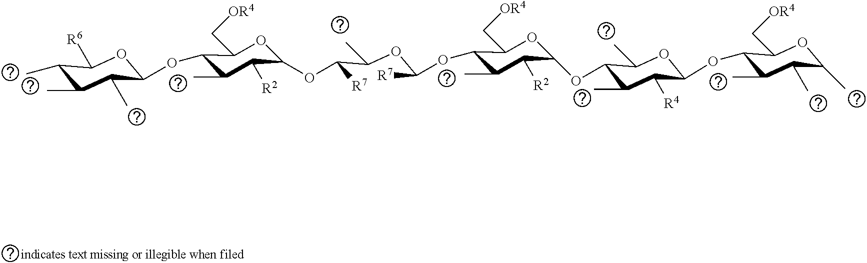

3. The hexasaccharide according to claim 1 wherein the hexasaccharide has formula:

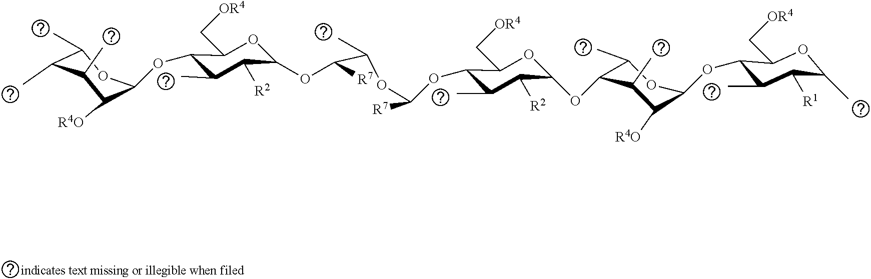

4. The hexasaccharide according to claim 1 wherein the hexasaccharide has formula 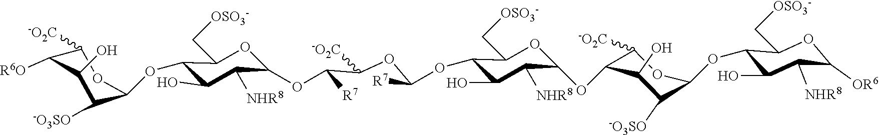
wherein R⁶ is selected from the group consisting of Me, Ethyl, Alkyl, alkyl azide, alkynyl, cholestanol aglycon;
R⁷ is selected from the group consisting of CH₂OH, COOH;
R⁸ is selected from the group consisting of SO₃Na, Ac.

5. The hexasaccharide according to claim 4 wherein the hexasaccharide has formula:

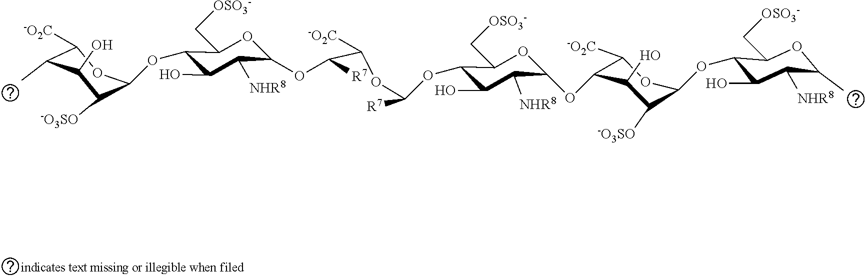

6. The hexasaccharide according to claim 4 wherein the hexasaccharide has formula: [chemical structure]
